(19) United States
(12) Patent Application Publication
(10) Pub. No.: US 2002/0176545 A1
(43) Pub. Date: Nov. 28, 2002

(54) Apparatus and method for broadcasting an emergency warning over a telephone network

(76) Inventor: Peter Schweitzer, Wayne, NJ (US)

Correspondence Address: THE LAW OFFICES OF THOMAS L. ADAMS, 120 EAGLE ROCK AVENUE, P.O. BOX 340, EAST HANOVER, NJ, 07936, US

(21) Appl. No.: 09/842,076

(22) Filed: Apr. 25, 2001

Related U.S. Application Data
(63) Continuation-in-part of application No. 09/131,524, filed on Aug. 10, 1998, now abandoned.

(51) Int. Cl. H04M 11/04

(52) U.S. Cl. 379/37; 379/48

(57) ABSTRACT

The emergency center can issue a broadcast signal destined to travel on a common channel signaling network. Switching equipment includes a switch for a switched telephone network. This switch can (a) establish telephonic communications between callers and called parties over a predetermined number of subscriber lines with a standard ring pattern, and (b) transmit an emergency ring pattern over a majority of the subscriber lines in response to a single command event conveyed to the switch over the common channel signaling network.

This is a continuation-in-part of application Ser. No. 09/131,524 filed Aug. 10, 1998.

### BACKGROUND OF THE INVENTION

1. Field of the Invention

The present invention relates to broadcast systems, and in particular to systems using a telephone network.

2. Description of Related Art

Civil defense, law enforcement, fire departments and other government organizations at various levels require a coordinated and effective early warning system to alert the populace of serious impending emergencies, such as hurricanes, tornadoes, explosions, chemical release, missile or terrorist attack, etc. Such a general early warning alarm should alert everyone, including those sleeping at night.

The use of sirens or speakers is feasible in densely populated areas, but will be ineffective in less densely populated or rural areas. In any event, there will always be individuals who are living in remote, isolated areas that will not be able to receive such an audible alarm.

A national warning system is currently implemented through established commercial radio and television channels. During an emergency, commercial broadcasts are over ridden to allow general early warning alarms. These systems require that the individual be currently paying attention to a commercial broadcast. This will obviously not be the case in all instances, especially during sleeping hours.

U.S. Pat. No. 5,166,972 shows using a distinctive ring for a small group of particular users, not for the entire general public. U.S. Pat. No. 4,250,353 shows a danger alarm system for sending alarms to a central exchange designed to handle these alarms. See also U.S. Pat. No. 5,493,611. None of these systems are designed to alert the general public.

### SUMMARY OF THE INVENTION

In accordance with the illustrative embodiments demonstrating features and advantages of the present invention, switching equipment is provided, which includes a switch for a switched telephone network. This switch can (a) establish telephonic communications between callers and called parties over a predetermined number of subscriber lines with a standard ring pattern, and (b) transmit an emergency ring pattern over a majority of the subscriber lines in response to a single command event.

In accordance with another aspect of the invention, switching equipment is provided with a switch for a switched telephone network that employs a common channel signaling network. The switch can (a) establish telephonic communications between callers and called parties over a plurality of subscriber lines with a standard ring pattern, and (b) transmit an emergency ring pattern in response to a single command event conveyed to the switch over the common channel signaling network.

According to yet another aspect of the invention, an emergency broadcast system with an emergency center operates in a communications system having a switched telephone network and a common channel signaling network. The emergency center can issue a broadcast signal destined to travel on the common channel signaling network. The broadcast signal has information designed to initiate on the switched telephone network: (a) switching that simultaneously connects a plurality of telephones; and (b) transmission of a distinct ring pattern to the plurality of telephones.

In accordance with still another aspect of the invention, a method is provided that employs a switched telephone network and a common channel signaling network for broadcasting an emergency signal. The method includes the step of receiving a broadcast signal on the common channel signaling network. Another step is performing switching on the switched telephone network in response to the broadcast signal in order to simultaneously connect a plurality of telephones. The method also includes the step of transmitting an emergency ring pattern to the plurality of telephones.

According to still yet another aspect of the invention, a method is provided that employs a switched telephone network and a common channel signaling network for broadcasting an emergency signal in response to a single command event. The method includes the step of establishing telephonic communications between callers and called parties over a predetermined number of subscriber lines with a standard ring pattern. Another step is transmitting an emergency ring pattern over a majority of the subscriber lines in response to a single command event.

The preferred system would use a pre-publicized, distinctive telephone ring as the universal signal to alert individuals. This unique ring will be advertised regularly to the public beforehand, so that they will know that they do not have to answer the phone, but should get to their radio or television set for emergency or safety instructions.

In some telephone areas with a large number of subscribers, blocks of databases could be established, so that each block of listed subscribers could be rung simultaneously, or immediately, with the above described technology.

The special alert, short double warning telephone ring can be transmitted simultaneously or immediately to the general public to warn of impending danger, by way of a computer ringing all subscribers on the database of a phone company.

In some cases, the special ringing signal will be transmitted in some areas to blocks of listed subscribers almost immediately after a computer is activated to pass on the special signal to everyone. Thus, the population could be alerted to get to their radio or television for safety Instructions.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a system diagram of a switched telephone network employing a common channel signaling network and switching equipment adapted to broadcast a warning;

FIG. 2 is a flow diagram for the system of FIG. 1;

FIG. 3 is a timing diagram showing a ring pattern invoked by the system of FIG. 1;

FIG. 4 is a timing diagram that is an alternate to that of FIG. 3; and

FIG. 5 is an architectural diagram for the system of FIG. 1

### DETAILED DESCRIPTION OF THE PREFERRED EMBODIMENTS

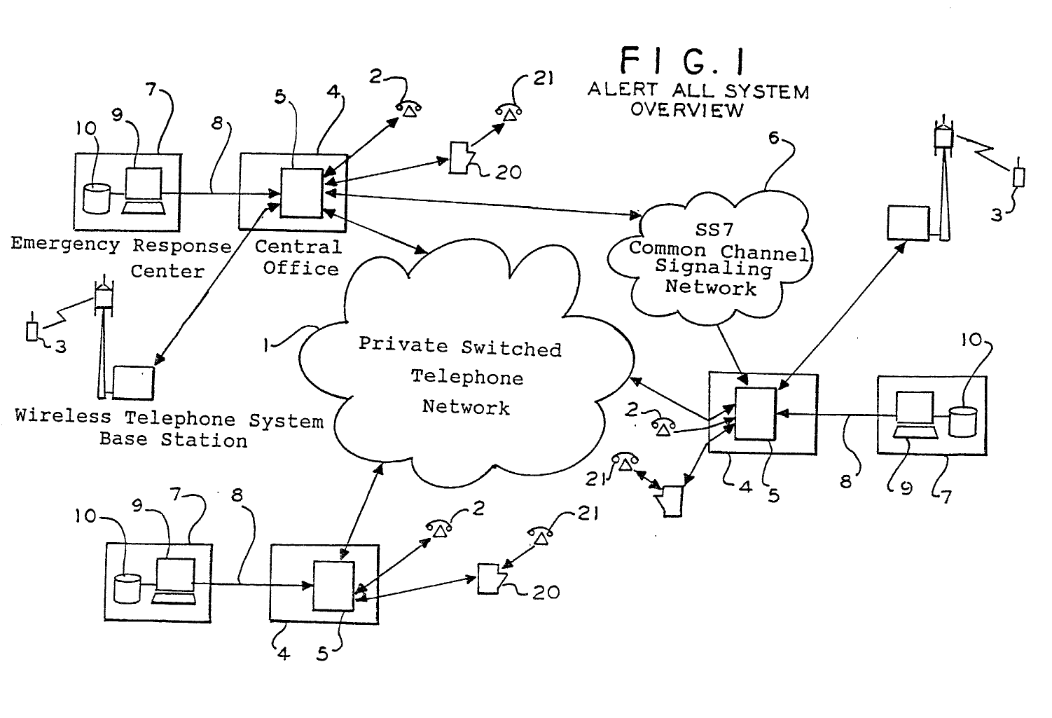

Referring to FIG. 1, the preferred warning system uses the public switched telephone network (PSTN) [1] to ring all connected wireline telephones [2] and wireless telephones [3] within specified geographic areas in a special way that alerts subscribers of impending emergencies.

This distinctive ringing capability would preferably be built into local telephone central office [4] switching equipment [5], according to universally adopted standards, similar to the Emergency-911 standards. As described hereinafter, ringing circuits [5a] would be added to the central office switching equipment. These circuits [5a] would be the same as existing ringing circuits, and would be connected in parallel with them in order to supplement their outputs. These added ringing circuits [5a] would have sufficient capacity to ring the required number of telephones [2] and would provide a universal distinctive ring. In addition, the central office [4] will be programmed to send a signal over link [3b] to wireless telephone system base station [3a], causing it to broadcast a special ringing activation signal to all subscribers or clients in its database. Individual cellular telephones [3] can be modified to respond to a special signal broadcast by base station 3a.

The entire population would be indoctrinated in advance through schools and mass media advertising to seek instructions from local broadcast media (radio and television), rather than answer the phone when the distinctive ring is heard.

The local phone companies' central office switches [5] would be programmed in advance to respond to a fixed set of emergency alert messages received over a link [6a] to an existing common channel signaling system [6], the current version thereof being referred to as Signaling System 7 (SS7). These messages would originate from the emergency response coordination center(s) [7] and would specify the area codes and exchanges to be alerted. Coordination centers [7] are shown associated with each central office [4], but this need not be the case, unless a high-level of redundancy and backup is deemed necessary. Therefore in some embodiments only a limited percentage of the central offices [4] will have an emergency response center [7] associated therewith.

To avoid overloading the ringing circuitry of the telephone companies' central office switching systems during an emergency, the central office switches [5] would be programmed to ring the designated subscriber telephones in pre-established tiers or groups.

Emergency Alert Message Injection

All alerts would originate from a centralized national emergency response coordination center, or a series of regional coordination centers [7], and be distributed over high reliability data link(s) [8] through local telephone company central offices [4] over the PSTN [1]. Arrangements would be coordinated in advance with these local phone companies to expect these emergency alert signals from the public telephone network's common channel signaling system [6].

Currently, the common channel signaling system [6] in use throughout the United States is known as the SS7. This or another parallel system would be modified to perform the emergency alert message distribution function. The required hardware and software modifications to the common channel signaling system would be made in accordance with technical standards that would be established for use by all central office switching equipment manufacturers.

The phone company(ies) selected to perform the alert message injection function would be required to participate in periodic drills and inspections to retain their status in the system.

Emergency Alert Messages

Emergency alert messages sent over the SS7 network [6] may identify the nature of the emergency and other operational parameters, such as priority and severity. They would also identify the area codes and telephone exchanges to be alerted, based on analysis, evaluation and forecasts made at the originating coordination center. To ensure uniformly reliable performance of this critical function, this targeting of geographical areas and the selection of the affected area codes and exchanges to be alerted would be the responsibility of the emergency management agency, rather than the local phone companies.

Database of Telephone Exchanges

Each emergency response center [7] would be equipped with the computer equipment [9] and related resources required to maintain a current database [10] of all area codes and exchanges within its span of control. The database at each control center [7] would be updated automatically by the phone companies in its control area as area codes and exchanges are added or modified. Audits would be conducted periodically to ensure the accuracy of these databases.

Alert Message Processing

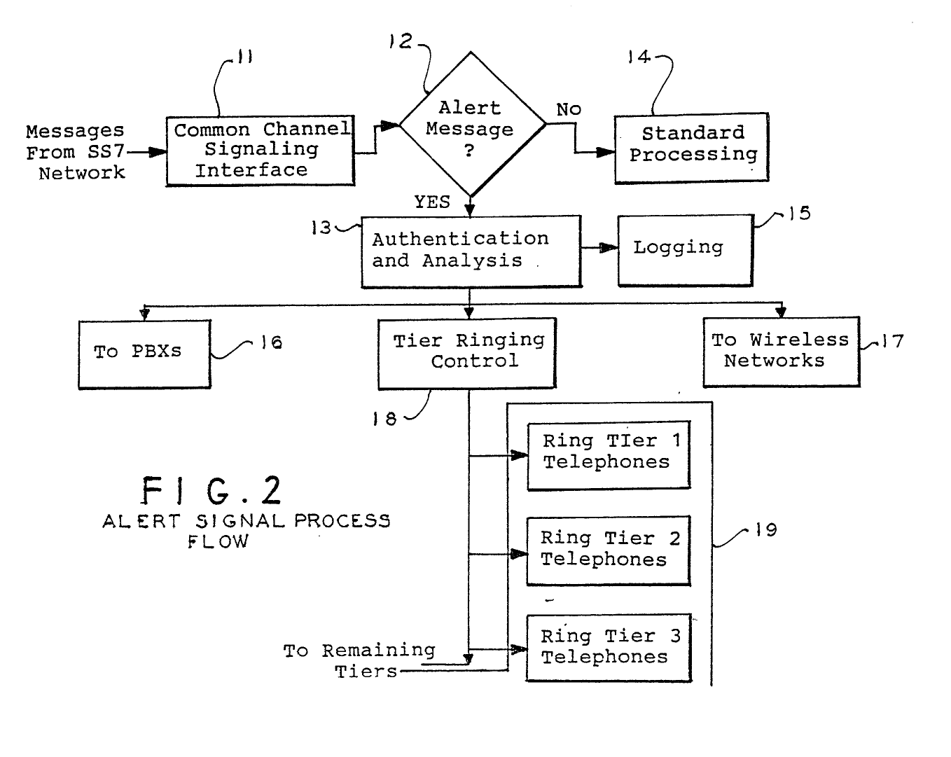

Referring to FIG. 2, the switches (switches [5] of FIG. 1) in the individual central offices run software that will be reprogrammed to implement the emergency alerting described in FIG. 2. The emergency alert messages forwarded via the SS7 common channel signaling network flow through an interface [11 ] at each telephone central office and would be recognized by the switching equipment [12] and authenticated [13]. Routine SS7 traffic would be processed [14] in the usual manner.

On the other hand, alert message parameters, such as time received, the nature of the emergency, urgency and priority, would be recorded in message logs [15]. Alert messages would be forwarded from the telephone central offices to selected PBXs [16] and wireless telephone networks [17], as appropriate, for distribution to phones connected to those systems that lie within the targeted geographic areas. In the central office, the tier ringing control logic [18] would ring pre-specified tiers or groups of phones [19] in a pre-determined sequence. This avoids ringing all telephones at once and creating a large instantaneous power drain on the system.

Alert Message Distribution Through the PSTN

Referring again to FIG. 1, distribution of the emergency alert messages from the central or regional center [7] can be accomplished using the SS7 common channel signaling system [6], which is a packet switched network connected to every central office [4] in the public telephone network. The engineering modifications necessary to adapt the SS7 system for this purpose would be governed by system-wide standards, applicable to the operating telephone companies and all manufacturers of telephone switching gear. These standards would apply to the capabilities that would be:

1. built into all newly installed central office equipment

2. retrofit into all existing central office equipment within a mandatory timeframe

Signal Distribution Through Private Networks and PBXs

To reach people at work and those living in multiple-unit residential buildings, such as hotels, the alert signal would be distributed to private branch exchanges (PBXs) [20] by a different link. Because PBXs are not on the SS7 network [6], all new PBXs built after a cutoff date would be programmed to receive and respond to special alert messages propagated through an auxiliary special signaling system that may be developed according to an industry standard. Special ringing circuits would be mandated for present and future PBXs to produce the distinctive ring on connected phones [21].

Ringing Standards and Circuits

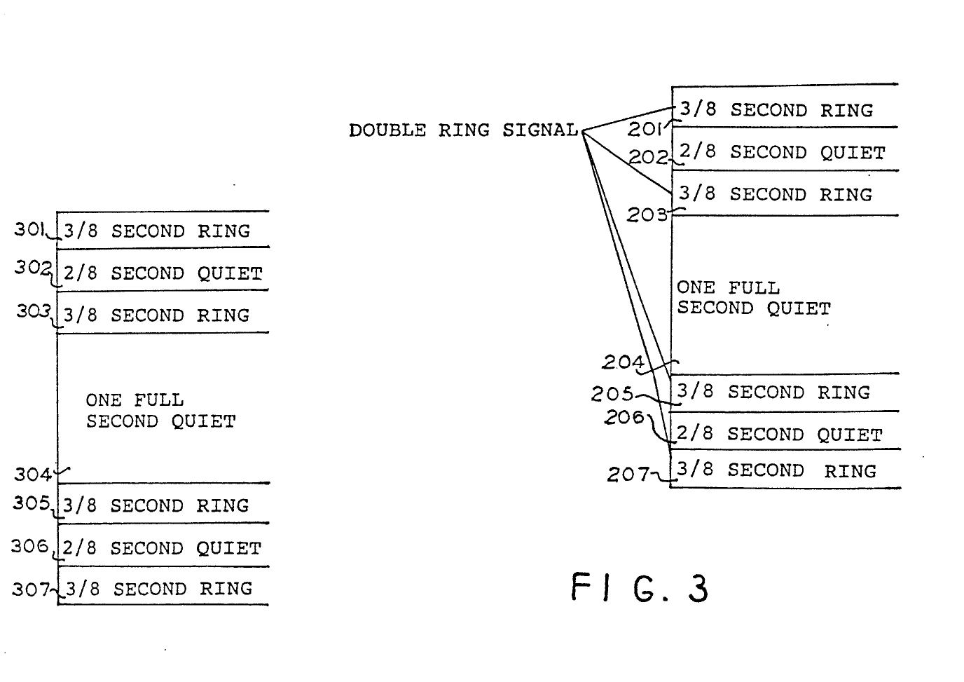

Referring to FIG. 3, the emergency alert distinctive ring [22] associated with the present system would consist of a series of short rings and interspersed pauses, which will be defined by an industry standard. Preferably, two double rings will be employed consisting of a first pair of rings [201, 203] followed by a one second pause [204] before the next double ring [205, 206, 207].

The ringing circuitry required to ring subscriber phones with the distinctive ring would consist of an electronic module (module [5a] of FIG. 1) that would be added to new and existing telephone switches (as well as PBXs). Wireless telephones would also be modified according to a standard to produce the distinctive ring.

Ringing Tiers

Because there are physical limits on the number of telephones that can be rung simultaneously by the ringing circuitry in telephone central office equipment and PBXs, the warning alert broadcasts would be staggered to avoid overloads. The phone numbers served by each public telephone switch and the extensions connected to each large PBX would be subdivided in advance and rung in an orderly arrangement of tiers (groups), with the phones in each tier being rung for an appropriate interval. After the entire population of phones in any serving area has received the warning, the cycle would be repeated, as appropriate, in the interest of reaching the maximum number of recipients.

In some embodiments, for a central office where there are a large number of listed subscribers, the company could break up the database into smaller blocks or groups, so that this program could be utilized to ring them sequentially, but with such short progressions that the ringing seems almost simultaneous.

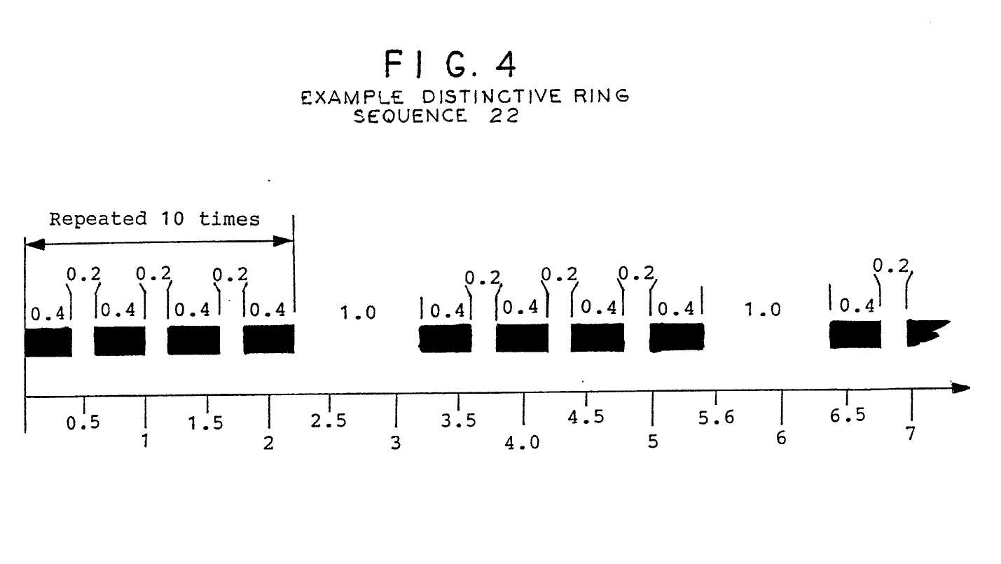

In one embodiment the target telephones are organized into two or more groups. In this arrangement during the pause between the two double rings in one group, a double ring is sent to another group. Accordingly, double rings can be interleaved as shown in FIG. 3 with double ring [304, 302, 303] occurring during pause [204] and double ring [305, 306, 307] following final ring [207]. Still other ring patterns are possible such as the sequence shown in FIG. 4.

Subscriber Response Training

To ensure proper response to the phone alerts, the national population would be trained in schools and through the mass media (similar to the Civil Defense training received during the “Cold War” period). Periodic drills would be held in schools, offices, plants, shops and similar facilities. These drills would involve:

1. Selecting target areas and determining the area codes and exchanges within those areas;

2. Injecting the warning messages into the PSTN;

3. Ringing all the telephones on public and private telephone networks in the target areas using the distinctive ring;

4. Broadcasting instructions over cooperating radio and television stations;

5. Monitoring the performance of the population within the target areas during drills; and

6. Evaluating and publishing the results

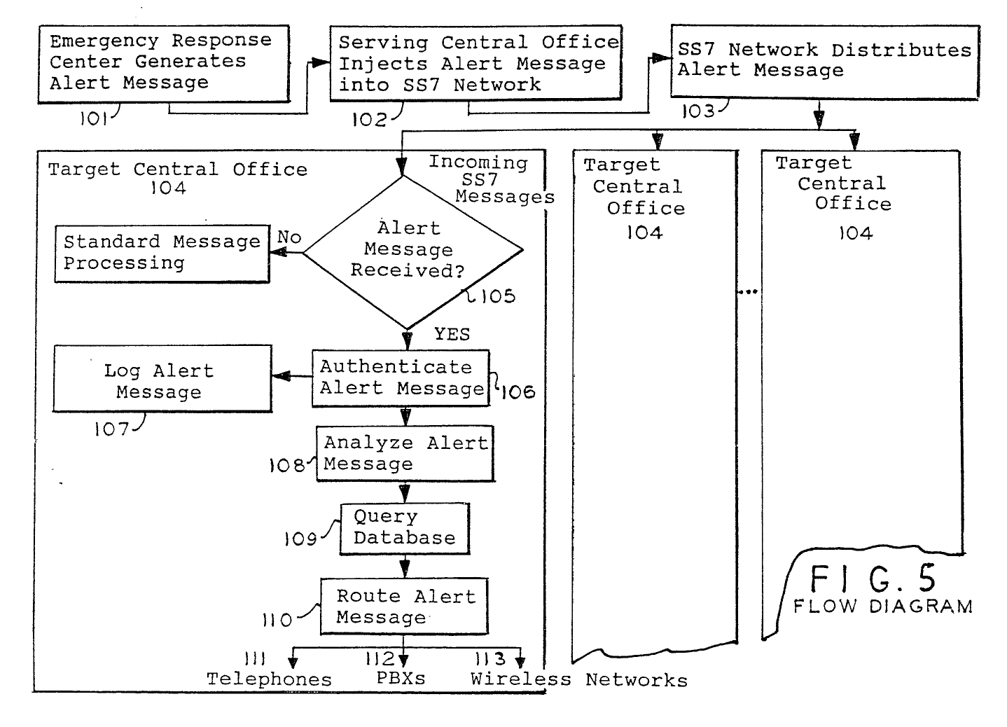

To facilitate an understanding of the principles associated with the foregoing apparatus, its operation will be briefly described in connection with the process flow diagram of FIG. 5. Using one of the emergency response centers [7] of FIG. 1 the civil defense or a governmental agency [101] can issue an emergency message [101], which can include a date and time stamp as well as an indication of the type of emergency. This emergency message will be issued over secure lines or through a radio transmission having a high level of encryption to the serving central office [102].

The serving central office [102] will generate and address an emergency alert message suitable for broadcast distribution over the SS7 common channel signaling system [103]. The message will include the area codes and telephone exchanges to be alerted. The message will be addressed to all target central offices [104] determined to be affected by the emergency situation. The SS7 network will broadcast this message simultaneously to all target central offices.

Upon receipt of the emergency alert message from the SS7 network, each target central office [104] in the affected area will scan [105] the message for the emergency alert indicator to separate alert messages from standard SS7 messages. Emergency messages will be authenticated [1 06] and logged [107]. The alert message will be analyzed [108] to extract the identities of the area codes and telephone exchanges of the affected telephones [111], and to identify the PBXs [112] and wireless network base stations [113] that should be included in the alert distribution. The central office database [109] will be used to look up the target telephone numbers, PBX parameters and wireless phone numbers to ring. The special ring signal will be broadcast by the other central offices [4], so that they can give this warning ring to all their subscribers, which will be a practical and inexpensive way to use the current technology to its best advantage, with little difficulty and no overwhelming of the telephone transmission system.

Phones off the hook and in use will be no problem since those people are likely to be aware of what is going on. This ring is especially valuable during the night, to alert people sleeping in homes or hospitals.

Obviously, many modifications and variations of the present invention are possible in light of the above teachings. It is therefore to be understood that within the scope of the appended claims, the invention may be practiced otherwise than as specifically described.

1. For a switched telephone network, switching equipment comprising:
a switch operating in said switched telephone network and operable to:
(a) establish telephonic communications between callers and called parties over a predetermined number of subscriber lines with a standard ring pattern, and
(b) transmit an emergency ring pattern over a majority of said subscriber lines in response to a single command event.

2. For a switched telephone network according to claim 1 wherein said switching equipment comprises:
a link for sending a broadcast signal signifying the occurrence of said single command event, in order to broadcast the need for a recurrence elsewhere of a response performed locally by said switch in response to said single command event.

3. For a switched telephone network according to claim 2 wherein said link comprises a common channel signaling network.

4. For a switched telephone network according to claim 2 wherein said link comprises a common channel signaling network coupled to said switch, said switch being operable to transmit said broadcast signal to said link.

5. For a switched telephone network according to claim 2 wherein said broadcast signal includes information signifying a destination for said broadcast signal.

6. For a switched telephone network according to claim 2 wherein said broadcast signal includes information signifying an emergency type.

7. For a switched telephone network according to claim 1 wherein said switching equipment comprises:
a database having information about said subscriber lines, said switching equipment being operable to send said emergency ring pattern to a portion of said subscriber lines from said database in response to said single command event.

8. For a switched telephone network according to claim 1 wherein said switching equipment is operable to transmit said emergency ring pattern at different times for different groupings of the subscriber lines.

9. For a switched telephone network according to claim 8 wherein said switching equipment is operable to multiplex said emergency ring pattern in order to ring in the same time period with a different phase.

10. For a switched telephone network according to claim 8 wherein said subscriber lines are segregated into a plurality of ordered tiers, said switching equipment being operable to sequentially ring individual ones of said ordered tiers exclusively before completing and sequencing to the next one of said tiers.

11. For a switched telephone network according to claim 1 wherein said switching equipment comprises:
a link for sending a broadcast signal signifying the occurrence of said single command event to one or more cellular telephone networks and PBXs, in order to broadcast the need for a recurrence elsewhere of a response performed locally by said switch in response to said single command event.

12. For a switched telephone network employing a common channel signaling network, switching equipment comprising:
a switch operating in said switched telephone network and operable to:
(a) establish telephonic communications between callers and called parties over a plurality of subscriber lines with a standard ring pattern, and
(b) transmit an emergency ring pattern in response to a single command event conveyed to said switch over said common channel signaling network.

13. For a switched telephone network according to claim 12 wherein said switching equipment comprises:
a link for sending a broadcast signal over said common channel signaling network signifying the occurrence of said single command event, in order to broadcast the need for a recurrence elsewhere of a response performed locally by said switch in response to said single command event.

14. For a switched telephone network according to claim 13 wherein said broadcast signal includes information signifying a destination for said broadcast signal.

15. For a switched telephone network according to claim 13 wherein said broadcast signal includes information signifying an emergency type.

16. For a switched telephone network according to claim 12 wherein said switching equipment comprises:
a database having information about said subscriber lines, said switching equipment being operable to send said emergency ring pattern to a portion of said subscriber lines from said database in response to said single command event.

17. For a switched telephone network according to claim 12 wherein said switching equipment is operable to transmit said emergency ring pattern at different times for different groupings of the subscriber lines.

18. For a switched telephone network according to claim 17 wherein said switching equipment is operable to multiplex said emergency ring pattern in order to ring in the same time period with a different phase.

19. For a switched telephone network according to claim 17 wherein said subscriber lines are segregated into a plurality of ordered tiers, said switching equipment being operable to sequentially ring individual ones of said ordered tiers exclusively before completing and sequencing to the next one of said tiers.

20. For a switched telephone network according to claim 12 wherein said switching equipment comprises:
a link for sending a broadcast signal signifying the occurrence of said single command event to one or more cellular telephone networks and PBXs, in order to broadcast the need for a recurrence elsewhere of a response performed locally by said switch in response to said single command event.

21. In a communications system having a switched telephone network and a common channel signaling network, an emergency broadcast system comprising:
an emergency center for issuing a broadcast signal destined to travel on said common channel signaling network and having information designed to initiate on said switched telephone network:
(a) switching that simultaneously connects a plurality of telephones; and
(b) transmission of a distinct ring pattern to said plurality of telephones.

22. In a communications system according to claim 21 wherein said broadcast signal includes information signifying a destination for said broadcast signal.

23. In a communications system according to claim 21 wherein said broadcast signal includes information signifying an emergency type.

24. In a communications system according to claim 21 wherein said emergency center comprises:
a link for sending the broadcast signal to one or more cellular telephone networks and PBXs.

25. A method employing a switched telephone network and a common channel signaling network for broadcasting an emergency signal, comprising the steps of:
receiving a broadcast signal on said common channel signaling network;
performing switching on said switched telephone network in response to said broadcast signal in order to simultaneously connect a plurality of telephones; and
transmitting an emergency ring pattern to said plurality of telephones.

26. A method according to claim 25 comprising the step of:
sending the broadcast signal over said common channel signaling network, in order to broadcast the need for a recurrence elsewhere of a response performed locally.

27. A method according to claim 26 wherein said broadcast signal includes information signifying a destination for said broadcast signal.

28. A method according to claim 26 wherein said broadcast signal includes information signifying an emergency type.

29. A method according to claim 25 wherein a database of subscriber lines is maintained for local switching equipment, the method including the step of:
sending said emergency ring pattern to a portion of said subscriber lines from said database in response to said broadcast signal.

30. A method according to claim 25 wherein the step of transmitting a ring pattern is performed by transmitting said emergency ring pattern at different times for different groupings of subscriber lines.

31. A method according to claim 30 wherein the step of transmitting a ring pattern is performed by multiplexing said emergency ring pattern in order to ring different lines in the same time period with a different phase.

32. A method according to claim 30 wherein a central office has jurisdiction over a plurality of subscriber lines that are segregated into a plurality of ordered tiers, the step of transmitting a ring pattern being performed by sequentially ringing individual ones of said ordered tiers exclusively before completing and sequencing to the next one of said tiers.

33. A method according to claim 25 comprising the step of:
sending the broadcast signal to one or more cellular telephone networks and PBXs, in order to broadcast the need for a recurrence elsewhere of a response performed locally in response to said broadcast signal.

34. A method employing a switched telephone network and a common channel signaling network for broadcasting an emergency signal in response to a single command event, comprising the steps of:
establishing telephonic communications between callers and called parties over a predetermined number of subscriber lines with a standard ring pattern, and
transmitting an emergency ring pattern over a majority of said subscriber lines in response to a single command event.

35. A method according to claim 34 comprising the step of:
sending a broadcast signal signifying the occurrence of said single command event, in order to broadcast the need for a recurrence elsewhere of a response performed locally in response to said single command event.

36. A method according to claim 35 wherein the broadcast signal includes information signifying a destination for said broadcast signal.

37. A method according to claim 35 wherein said broadcast signal includes information signifying an emergency type.

38. A method according to claim 34 wherein a database of subscriber lines is maintained for local switching equipment, the method including the step of:
sending said emergency ring pattern to a portion of said subscriber lines from said database in response to said single command event.

39. A method according to claim 34 wherein the step of transmitting an emergency ring pattern is performed by transmitting said emergency ring pattern at different times for different groupings of lines.

40. A method according to claim 39 wherein the step of transmitting an emergency ring pattern is performed by multiplexing said emergency ring pattern in order to ring different lines in the same time period with a different phase.

41. A method according to claim 39 wherein a central office has jurisdiction over a plurality of subscriber lines that are segregated into a plurality of ordered tiers, the step of transmitting a ring pattern being performed by sequentially ringing individual ones of said ordered tiers exclusively before completing and sequencing to the next one of said tiers.

42. A method according to claim 34 wherein comprising the step of:
sending a broadcast signal signifying the occurrence of said single command event to one or more cellular telephone networks and PBXs, in order to broadcast the need for a recurrence elsewhere of a response performed locally in response to said single command event.
